(19) United States
(12) Patent Application Publication
(10) Pub. No.: US 2015/0001151 A1
(43) Pub. Date: Jan. 1, 2015

(54) WATER TREATMENT SYSTEM, AND WATER TREATING METHOD IN WATER TREATMENT SYSTEM

(71) Applicant: Hitachi, Ltd., Tokyo (JP)

(72) Inventors: Keiko NAKANO, Tokyo (JP); Kotaro KITAMURA, Tokyo (JP); Misaki SUMIKURA, Tokyo (JP)

(73) Assignee: Hitachi, Ltd.

(21) Appl. No.: 14/308,734

(22) Filed: Jun. 19, 2014

(30) Foreign Application Priority Data
Jun. 27, 2013 (JP) 2013-134677

(51) Int. Cl. B01D 61/18; C02F 1/44; B01D 61/08

(52) U.S. Cl. CPC B01D 61/18; B01D 61/08; C02F 1/441; C02F 1/444
USPC 210/650; 210/94

(57) ABSTRACT

In a water treatment system, fouling is made earlier detectable, considering additionally the effect of spacers arranged between its separating membrane layers.

A water treatment system 1 includes a pre-treating unit for pre-treating a raw water; a desalting unit having a separating membrane unit for separating substance to be separated from the raw water pre-treated in the pre-treating unit, using a separating membrane; and a monitoring unit between the pre-treating unit and the desalting unit. The monitoring unit has a monitor device fitted to a bypass pipe and configured to have a closed vessel having at least one transparent or semitransparent surface, and an image-pickup device which makes the raw water flowing in this vessel visible through the transparent or semitransparent surface. In the vessel, separating membrane layers which the separating membrane unit has, and a fouling-generating member are arranged to be put onto each other. This fouling-generating member imitates spacers for keeping, apart from each other, the separating membrane layers of the separating membrane arranged in the separating membrane unit.

### CLAIM OF PRIORITY

The present application claims priority from Japanese Patent application serial No. 2013-134677, filed on Jun. 27, 2013, the content of which are hereby incorporated by reference into this application.

### FIELD OF THE INVENTION

The present invention relates to a water treatment system for purifying water, and a water treating method therein, in particular, a water treatment system suitable for the case of using an RO membrane to purify water, and a water treating method therein.

### BACKGROUND OF THE INVENTION

In water treatment systems for purifying a raw water such as seawater or wastewater, an important theme for the operation thereof is to prevent fouling of their separating membrane. It is therefore evaluated, in connection with the quality of the water, what level of substances for causing the fouling is contained in the raw water or a pre-treated water (water for supplying the separating membrane), and then a pre-treatment for the raw water is controlled. An example of such a water treating method is described in WO 2008/038575.

Ina reverse osmosis membrane filtration plant described in this publication WO 2008/038575, at the time of performing a method of operating the reverse osmosis membrane filtration plant that is a plant having a raw-water-taking unit, a pre-treating unit, and a reverse osmosis membrane filtration unit having a reverse osmosis membrane module in this unit-described order, a biofilm forming substrate is arranged therein under a condition that a reverse-osmosis-membrane supplying water and/or a reverse-osmosis-membrane non-penetration water inside the reverse osmosis membrane filtration unit is/are caused to flow at a linear velocity equivalent to the velocity of a non-penetration water inside the reverse osmosis membrane module of the reverse osmosis membrane filtration unit. In this situation, the quantity of a biofilm in the form of the biofilm forming substrate is estimated at intervals of from one day to sixth months, and then on the basis of results of the estimation, the plant operating method is controlled. As the biofilm forming substrate, particularly, a reverse osmosis membrane used in reverse osmosis membrane filtration plants is used.

JP 2008-107330 A describes a device, for evaluating a risk of the generation of biofouling, which has a water passing tank, a biofilm forming unit in which substrates are arranged which each have a transparent surface on which a biofilm arranged in water in the water passing tank can be formed, a connection unit capable of supplying water into the water passing tank, and an outflow unit capable of discharging the water in the water passing tank, whereby the state of the process (concerned) is quantitatively determined and evaluated rapidly with a good sensitivity and precision at any time, using a simple and inexpensive device structure.

J. S. Vrouwenvelder, et. al., Journal of Membrane Science, vol. 281, pp. 316-324, 15 Sep. 2006 discloses a fouling simulator as a tool for forecasting and controlling fouling. The simulator described in this literature has a membrane that is identical with a spiral RO (reverse osmosis) membrane and shows a size and a flowing situation equivalent thereto; and a sight glass.

### Patent Documents

Patent Document 1: WO 2008/038575

Patent Document 2: JP 2008-107330 A

### Non Patent Document

Non Patent Document 1: J. S. Vrouwenvelder, et. al., Journal of Membrane Science, vol. 281, pp. 316-324, 15 Sep. 2006 Fouling denotes, in a narrow sense, a rise in the intermembrane differential pressure of a separating membrane by blockage or some other of the membrane. In a separating membrane used in any water treatment system which the present invention handles, it is necessary to hold a membrane of many membrane layers into a membrane element having a small volume. Thus, this separating membrane adopts hollow fibers, and a spiral structure or such a structure, and further a flowing channel between any two of the membrane layers is made narrow. Consequently, a deposit deposited onto the separating membrane layers, and others block the flowing channel to make the water passing resistance thereof high. Under a condition that the blockage of this flowing channel is interpreted as fouling in a wide sense, the following description will be made.

About the reverse osmosis membrane filtration plant described in the above-mentioned literature WO 2008/038575, attention is paid to a matter that reverse osmosis membranes, which are separating membranes, are blocked by a raw water or a pre-treated water flowing into the reverse osmosis membranes, so that a branched pipe branched from a main current of the water is fitted to a reverse osmosis membrane filtration unit unit, and a water passing tank holding a biofilm forming substrate is arranged in the middle of this pipe. From this water passing tank, the biofilm forming substrate is partially taken out at intervals of from one day to six months, and then a measurement is made about the biofilm quantity on the surface of the biofilm forming substrate.

However, in the system described in this literature WO 2008/038575, it is necessary for estimating the quantity to stop the flowing movement of the raw water or the pre-treated water in the water passing tank, and specialize an instrument for the estimation. Thus, the number of steps for the treatment increases. Furthermore, only channel blockage based on the separating membranes is considered; accordingly, a sufficient consideration is not made about fouling based on spacers interposed between the separating membranes. Additionally, according to this estimating method, the water passing resistance of the channel is not detected. Thus, this technique cannot cope with a tackling method on the actual spot, which is a method of discovering the creation of fouling through a change in the water passing resistance and which makes an estimation more easily.

The publication JP 2008-107330 A states that a connection unit of a monitoring device for a membrane process is connected to a branched pipe of a main pipe path. However, even when the monitoring device is connected to the branched pipe in this way, the velocity of the formation of fouling becomes equivalent to that in the main pipe path when conditions of the branched pipe is equivalent to those of the main pipe. For this reason, fouling cannot be earlier detected in the branched pipe than in the main pipe path. In this literature, the biofilm forming unit is in a planar form. Thus, no consideration is made about fouling generated by spacers interposed between the separating membranes when the unit is in a spiral form.

In the fouling simulating device described in the above-mentioned non patent document Journal of Membrane Science, its channel is formed to be caused to approximate its actual membrane element, so that the water passing resistance based on blockage thereof can be detected. However, this device monitors fouling based on a rise in the intermembrane differential pressure. Thus, until any intermembrane differential pressure is generated by the generation of fouling, the generation of fouling can not be detected.

In light of the above-mentioned prior art, the present invention has been made. An object of the present invention is to provide a water treatment system capable of detecting fouling early, making a consideration also about an effect of one or more spacers between separating membrane layers having a spiral structure. Another object of the present invention is to make it possible to detect fouling without disassembling or stopping the water treatment system.

### SUMMARY OF THE INVENTION

The present invention for achieving the object is a water treatment system comprising a pre-treating unit for pre-treating a raw water, a desalting unit having a separating membrane unit for a separating substance to be separated from the raw water pre-treated in the pre-treating unit, using a separating membrane, and a monitoring unit between the pre-treating unit and the desalting unit, wherein: the separating membrane unit has an RO membrane element in which separating membrane layers arranged as the separating membrane, and one or more spacers for keeping the separating membrane layers apart from each other are formed to be wound into a spiral form; the monitoring unit has a monitor device fitted to a bypass pipe of a pipe through which the pre-treating unit and the desalting unit are connected to each other, and configured to comprise a closed vessel having at least one transparent or semitransparent surface, and an image-pickup device which makes the raw water flowing in this vessel visible through the transparent or semitransparent surface; inside the vessel, a fouling-generating member that imitates the separating membrane and the spacers is arranged; the image-pickup device makes it possible to pick up an image of the raw water flowing in the fouling-generating member through the transparent or semitransparent surface; and the monitoring device has a structure in which fouling is more easily generated than in the structure which the desalting unit has.

The water treating method of the present invention in a water treatment system having a separating membrane unit of using a separating membrane to separate, from a raw water, a substance to be separated is a method for preventing blockage of the separating membrane that is based on fouling generated by adsorption of the substance to be separated into the separating membrane unit, this method being further a method of bypassing the raw water at the upstream side of the separating membrane unit, causing the bypassed raw water to flow into a monitoring device having therein a fouling-generating member having a structure in which fouling is more easily caused than in the separating membrane and a spacer which the separating membrane unit has, and picking up an image of the raw water flowing into the fouling-generating member through an image-pickup device, thereby forecasting the generation of the fouling.

According to the present invention, fouling, examples thereof also including fouling caused by the spacer, can come to be earlier detected. Furthermore, the fouling can be monitored without disassembling or stopping the water treatment system.

### BRIEF DESCRIPTION OF THE DRAWINGS

FIG. 1 is a system chart of one embodiment of the seawater desalting system according to the present invention;

FIGS. 2A, 2B and 2C are, respectively, a partially exploded perspective view, a side view and a partially detailed view of any one of elements in the seawater desalting system illustrated in FIG. 1;

FIGS. 3A and 3B are, respectively, a vertical sectional view and a top view of a monitoring unit in the seawater desalting system illustrated in FIG. 1;

FIG. 4 is a schematic view of an example of a fouling-generating member in the seawater desalting system illustrated in FIG. 1;

FIG. 5 is a schematic view of another example of the fouling-generating member;

FIGS. 6A and 6B are schematic views of another example of the fouling-generating member, and the former is a top view thereof, and the latter is a vertical sectional view illustrating the fouling-generating member integrated into the monitoring unit;

FIG. 7 is a graph demonstrating a relationship between a change in the water passing resistance of a monitoring unit, and the generation of fouling; and

FIG. 8 is a flowchart of a method of operating a seawater desalting system in order to control fouling.

### DETAILED DESCRIPTION OF THE PREFERRED EMBODIMENTS

Hereinafter, the water treatment system according to the present invention will be described in detail with reference to the attached drawings. In any water treatment system, substances to be separated are removed from a raw water or pre-treated water. For the removal of the substances, a separating membrane is used in many cases. Ina water treatment system using a separating membrane, the separating membrane may be, for example, a precise filtration membrane, an ultrafiltration membrane, a reverse osmosis membrane (RO membrane), a nano-filter membrane (NF membrane), or an ion exchange membrane. Of such membranes, a reverse osmosis membrane (RO membrane) is suitable for seawater desalting, and is frequently used therefor. Thus, the following description will be made about a seawater desalting system, using an RO membrane having an element structure.

It is sufficient for the present invention that a structure is used in which one or more spacers and a separating membrane (multilayered separating membrane composed of separating membrane layers) that will be detailed hereinafter are in contact with each other. The separating membrane is not limited to any RO membrane. In other words, for example, an NF membrane or ion exchange membrane is usable as the separating membrane. The water treatment system is not limited to any seawater desalting system, either, and may be, for example, a reusable water producing system for purifying groundwater, river water, wastewater or any other water to generate reusable water, or a pure water or ultrapure water producing system for producing pure water or ultrapure water.

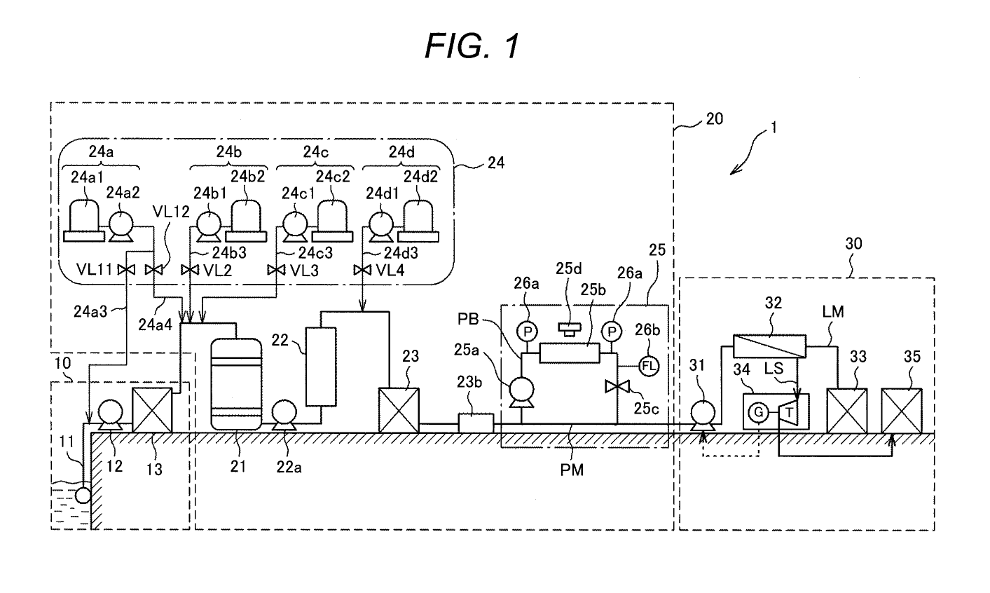

FIG. 1 shows a system chart illustrating a seawater desalting system 1 as one embodiment of a water treatment system. The seawater desalting system 1 removes, as substances to be separated, salts, organic substances, microorganisms, fungi, boron, suspended solid matters, which are suspensoids, and others to attain seawater desalination. For this purpose, as main units thereof, a seawater taking unit 10, a pre-treating unit 20, and a desalting unit 30 are arranged in turn from the upstream side thereof. Organisms referred to hereinafter also include fungi.

The seawater taking unit 10, which is positioned at the topmost upstream side of the seawater desalting system 1, has a water taking pipe 11 through which seawater is taken into this seawater desalting system 1, a water taking pump 12 for pumping up seawater, and a raw water tank 13 in which the pumped-up seawater is collected and stored.

The water taking pipe 11 may have a structure in which the tip thereof is put into a sea to take seawater that is used as a raw material, or a structure extended to the offing to take deep water as a raw water. The pipe 11 may have a structure embedded below the seabed so that seawater (as a raw water) is filtrated through seabed sand and then taken. In order to prevent an inconvenience that microorganisms, algae, shellfish and others proliferate in the water taking pipe 11 to block the water taking pipe 11, chemical agents (such as sterilizers) for preventing the proliferation of these organisms may be put into the water taking pipe 11. The water taking pump 12 may be set on land as shown in FIG. 1, or may be set in a sea.

The pre-treating unit 20 for treating the seawater taken by the seawater taking unit 10 has a sand filtration tank 21, a water sending pump 22a, an ultrafiltration membrane unit 22, and a supplying water tank 23. The sand filtration tank 21 includes therein a predetermined volume of sand to separate suspended components (organic substances), as some of the substances to be separated. The ultrafiltration membrane unit 22 has an ultrafiltration membrane through which microorganisms and others are filtrated. The water sending pump 22a supplies the filtrated water from the sand filtration tank 21 into the ultrafiltration membrane unit 22. The supplying water tank 23 temporarily collects and stores the water from the unit 22 as a raw water to be supplied into an RO membrane unit 32 that the desalting unit 30 at the downstream side has.

The pre-treating unit 20 performs a pre-treating step of sterilizing living microorganisms, and removing other organic substances. For this purpose, the pre-treating unit 20 has a chemical-agent-injecting system 24 for injecting plural chemical agent species into the raw water. Injecting parts of the chemical agent injecting system 24 are set correspondingly to the chemical agent species, respectively. The injection parts each have a tank in which one of the chemical agent species is stored, and a liquid sending pump. In the seawater desalting system 1 as shown in FIG. 1, the chemical-agent-injecting system 24 has, as these injecting parts, a sterilizer injecting part 24a, a pH adjustor injecting part 24b, a coagulant injecting part 24c, and a neutralizing/reducing agent injecting part 24d.

The sterilizer injecting part 24a has a sterilizer storing tank 24a1, and a liquid sending pump 24a2. Therefrom, a sterilizer for sterilizing microorganisms is injected through pipes 24a3 and 24a4 to the raw water taking pipe 11 or the upstream side of the sand filtration tank 21. In the middle of each of the pipes 24a3 and 24a4, an adjusting valve VL11 or VL12 is located. The pipe 24a3, through which the sterilizer is injected into the raw water taking pipe 11, may be omitted in accordance with the degree of the pollution of the seawater.

From this sterilizer injecting part 24a, hypochlorous acid, chlorine or some other is injected, as the sterilizer for sterilizing microorganisms, into the raw water. The sterilizer is intermittently injected from the sterilizer injecting part 24a. The death rate or survival rate of the microorganisms in the raw water is varied in accordance with the injection interval or concentration of the sterilizer. Thus, the injection volume or interval of the sterilizer is controlled, using the adjusting valves VL11 and VL12.

Hypochlorous acid, or chlorine injected as the sterilizer causes a decline in the membrane function of the RO membrane included in the RO membrane unit 32 in the desalting unit 30. As will also be described later, therefore, the raw water is reduced before the raw water is sent into the RO membrane unit 32, and further an excessive injection of the sterilizer is avoided.

The pH adjustor injecting part 24b has a storing tank 24b2 for a pH adjustor, and a liquid sending pump 24b1. Therefrom, the pH adjustor is injected through a pipe 24b3 to the upstream side of the sand filtration tank 21 to prevent the generation of scales of multivalent ions and improve the efficiency of the coagulation. In the middle of the pipe 24b3, an adjusting valve VL2 is located.

In order to prevent the generation of scales of multivalent ions and improve the efficiency of the coagulation, the raw water to be treated by the seawater desalting system 1 is preferably adjusted to an acidity (pH: 3 to 5). Thus, from the pH adjustor injecting part 24b, the pH adjustor, such as sulfuric acid, is injected into the raw water to adjust the pH thereof appropriately. The injection amount of the pH adjustor is controlled by the adjusting valve VL2.

The coagulant injecting part 24c has a coagulant storing tank 24c2 and a liquid sending pump 24c1. Therefrom, a coagulant is injected through a pipe 24c3 to the upstream side of the sand filtration tank 21 to remove suspended components (organic substances), as substances to be separated, effectively in the sand filtration tank 21. In the middle of the pipe 24c3, an adjusting valve VL3 is located.

From the coagulant injecting part 24c, polyaluminum chloride, ferric chloride or some other is injected, as the coagulant, into the raw water. The coagulant promotes the growth of flocks of the suspended components (organic substances) contained in the raw water. By the injection of the coagulant, fine particles 0.1 μm or more in size, out of the suspended components, easily grow to flocks 1 μm or more in size to improve the efficiency of the removal of the suspended components in the sand filtration tank 21.

If the injection amount of the coagulant is too small, the growth of the flocks becomes insufficient so that the suspended components (organic substances) as the substances to be separated may pass through the sand filtration tank 21. Contrarily, if the injection amount of the coagulant is too large, an excess of the coagulant, which is not used to grow the flocks, gives a load to the RO membrane which the RO membrane unit 32 of the desalting unit 30 has. Thus, the injection amount of the coagulant is controlled, using the adjusting valve VL3.

The neutralizing/reducing agent injecting part 24d has a neutralizing/reducing-agent-storing tank 24d2, and a liquid sending pump 24d1. Therefrom, a neutralizing agent and/or a reducing agent is/are injected through a pipe 24d3 to a spot at the downstream side of the ultrafiltration membrane unit 22 and the upstream side of the supplying water tank 23. In the middle of the pipe 24d3, an adjusting valve VL4 is located. In the neutralizing/reducing agent injecting part 24d, as the neutralizing and/or reducing agent, a neutralizing agent for neutralizing the raw water, the pH of which is adjusted into the acidity of 3 to 5, and/or a reducing agent for reducing mainly the sterilizer is/are injected into the raw water. The injection amount of the neutralizing and/or reducing agent is controlled, using the adjusting valve VL4.

A characteristic structure of the present invention is that the monitoring unit 25 for monitoring fouling generated when the neutralized raw water flows through the RO membrane unit 32 is located between the supplying water tank 23 at the downmost downstream side of the pre-treating unit 20 and the desalting unit 30. In other words, a safety filter 23b is located at the downstream of the supplying water tank 23 and next to the tank 22. Through this safety filter 23b, the following, out of the substances to be separated, are removed: ones not removed in the pre-treating unit 20; ones formed by re-coagulation of fine organic substances until the raw water flows into the safety filter 23b; and organic substances and others peeled from the pipes and having a size of several micrometers. Ones having a size more than 1 μm, out of the substances to be separated, are removed in the pre-treating unit 20.

The raw water flowing out from the safety filter 23b is branched into a main pipe PM and a branched pipe PB to flow. Almost all of the raw water flows through the main pipe PM to the desalting unit 30. The rest of the raw water is sent to a monitoring device 25b by a pump 25a located at the branched pipe PB. The flow rate of the raw water flowing in the branched pipe PB is determined by controlling an adjusting valve 25c in the middle of the branched pipe on the basis of outputs from pressure gauges 26a and a flow meter 26b located at the branched pipe PB. The monitoring device 25b is made visible, which will be detailed later. An image pickup camera 25d is arranged in close vicinity of the monitoring device 25b. The raw water that has passed through the monitoring device 25b is mixed with the flow inside the main pipe PM to be sent into the desalting unit 30 at the downstream side of the present system.

The desalting unit 30 is equipped with a main line LM having a high-pressure pump 31, the RO membrane unit 32, and a plain water tank 33, and a secondary line LS having the RO membrane unit 32, an energy recovering unit 34, and a concentrated water tank 35. The high-pressure pump 31 arranged in the main line LM gives a pressure necessary for causing the raw water to flow to overpower the channel resistance of the RO membrane unit 32.

In the RO membrane unit 32, which has the RO membrane, a semipermeable membrane is used in the front surface of the RO membrane. The semipermeable membrane is a membrane through which only water molecules permeate by a difference, in interaction with the membrane, between the water molecules and the substances to be separated. This membrane may be a cellulose acetate type membrane, or an aromatic polyamide type membrane. Of the two, the latter RO membrane is widely used as an industrial semipermeable membrane since the membrane is high in water-molecule-permeating performance, and electrolyte-removing performance.

A membrane element formed by winding plural layers of at least one polyamide type RO membrane around a central axis is called a spiral type element. A commercially available spiral type element is standardized by each company, and is made into the form of a cylinder having a length of about 1 m, and a diameter of 4 inches (about 10 cm), 8 inches (about 20 cm) or 16 inches (about 40 cm). The RO membrane unit 32 is formed by fabricating pressure-resistant containers called vessels (the number thereof: for example, 20) into a matrix form, these vessels being each a vessel in which such membrane elements (the number thereof: for example, 6) are arranged in series. In the plain water tank 33, the raw water from which the substances to be separated have been removed through the RO membrane unit 32 is stored as plain water.

The energy recovering unit 34, which constitutes a part of the secondary line LS, is composed of a turbine rotatable by energy generated when high-pressure concentrated water (high-pressure water) stored in the concentrated water tank 35 is discharged, and a power generator connected to this turbine. The concentrated water is being pressurized by the high-pressure pump 31, and contains the substances to be separated. Electric power generated by the energy recovering unit 34 is used as driving power for the high-pressure pump 31, and others. Another method for the pressurization may be a method using a unit having a first turbine rotatable by energy generated when high-pressure concentrated water is discharged, and a second turbine fitted to an axis of the first turbine at the first-turbine-opposite side of the axis (not shown). In this method, a low-pressure supplying water is partially supplied thereto to pressurize the water. The concentrated water tank 35 is a tank wherein a concentrated water, which is a portion of the raw water that has not permeated the RO membrane of the RO membrane unit 32, is stored.

The following will detail the action of the seawater desalting system configured as described above. In the seawater desalting system 1, the water taking pump 12 of the seawater taking unit 10 takes up seawater (as a raw water) through the water taking pipe 11 from a sea. The taken raw water is temporarily stored in the raw water tank 13. Substances which are contained in the raw water and are to be separated partially precipitate inside the raw water tank 13, so as to be removed. The raw water is then sent into the pre-treating unit 20.

In the pre-treating unit 20, a sterilizer is injected from the sterilizer injecting part 24a into the raw water, a pH adjustor is injected from the pH adjustor injecting part 24b into the raw water, and further a coagulant is injected from the coagulant injecting part 24c into the raw water. The raw water in which these chemical agents are injected is introduced into the sand filtration tank 21. Flocks of the substances to be separated (organic substances) that have been grown into a size of 1 μm or more mainly with the coagulant, in the raw water, are filtrated in the sand filtration tank 21 to be removed. The raw water that has permeated the sand filtration tank 21 is sent into the ultrafiltration membrane module 22 by the water sending pump 22a.

In the ultrafiltration membrane module 22, from the raw water, the following are separated and removed: the substances to be separated which have a size of 0.05 μm or more, which is smaller than the size of the substances to be separated which have filtrated in the sand filtration tank 21; polymers each having a molecular weight of several thousands; bacteria; and others. Microorganisms contained in the raw water, such as the bacteria, are removed in a proportion of about 100% through the ultrafiltration membrane module 22.

At this time, the raw water is pressurized into a pressure of about 0.1 to 0.5 MPa by the water sending pump 22a, and sent into the ultrafiltration membrane module 22. As the raw water sent into the ultrafiltration membrane module 22 has a higher pressure, the raw water becomes higher in velocity when the raw water permeates the ultrafiltration membrane module 22. However, as the raw water is made higher in pressure, the performance for separating, from the raw water, the substances to be separated (separating performance) becomes lower.

A neutralizing agent and a reducing agent are injected from the neutralizing/reducing agent injecting part 24d into the raw water that has permeated the ultrafiltration membrane module 22. The raw water, the pH of which has been adjusted with the pH adjustor, is neutralized with the neutralizing agent. At the same time, the sterilizer injected therein is reduced with the reducing agent. The thus neutralized and reduced raw water is collected and stored in the RO membrane supplying water tank 23.

The raw water stored in the RO membrane supplying water tank 23 is sent under pressure into the RO membrane unit 32 by the high-pressure pump 31, and then filtrated through the RO membrane unit 32. The resultant raw water portion, from which the substances to be separated have been removed through the RO membrane unit 32, is collected and stored in the plain water tank 33. The raw water portion which has not permeated the RO membrane of the RO membrane unit 32 turns into a concentrated water containing the substances to be separated, so as to be collected and stored in the concentrated water tank 35.

The seawater desalting system 1 may have a drainage system for returning the concentrated water stored in the concentrated water tank 35 to, for example, the sea. In this case, the drainage system needs to conduct a treatment for lowering the salt concentration, and a treatment for separating substances usable as raw materials of salt and chemical agents.

The RO membrane which the RO membrane unit 32 has is a semipermeable membrane, and acts as a separating membrane which only water molecules permeate. When fouling is generated in this separating membrane, a decrease is caused in the separating performance of separating, from the raw water, the substances to be separated, or in the treating performance. Specifically, in a case where fouling is generated in an operation of the membrane unit formed by fabricating, into a matrix form, plural cylindrical vessels in which plural membrane elements are held, the following is caused: the pressure is raised when the operation is one in which the permeation water amount is constant; or the permeation water amount is lowered when the operation is one in which the pressure is constant.

In order to avoid this inconvenience, a process in a water treatment system including the seawater desalting system includes, as a treatment step for preventing fouling of the separating membrane, a pre-treating step of removing, in advance, substances which may cause the fouling and are to be separated. Even when fouling is generated, the method for cleaning the separating membrane is varied in accordance with the pore diameter and the strength of the separating membrane to discharge the fouling-causing substances from the inside of the membrane elements, thereby maintaining the membrane unit.

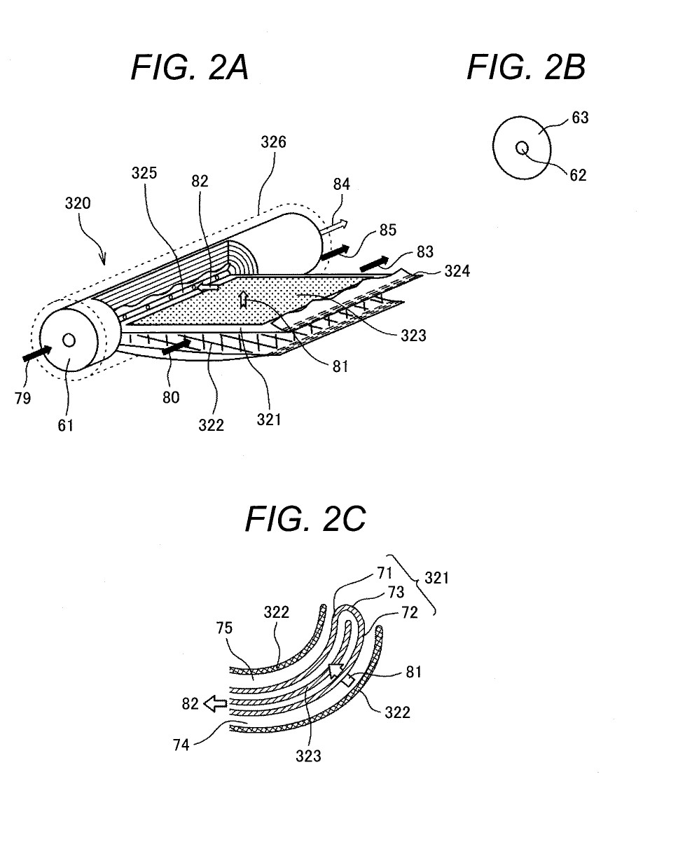

Referring to FIGS. 2A, 2B and 2C, the following will describe details of a membrane element 320 having a spiral structure as any one of the membrane elements used as the RO membrane in the seawater desalting system 1 as shown in FIG. 1. FIG. 2A is a perspective view of this membrane element 320, which is a membrane element example related to the present invention, and is a view illustrating the element in the state of being partially cut open. FIG. 2B is a right-side side view of the membrane element 320, and FIG. 2C is a sectional view that partially illustrates the membrane element 320.

In this membrane element 320 having the spiral structure, cross flow filtration is realized. In the cross flow filtration, a supplied water 79 flows in parallel to surfaces of separating membrane layers (or sheets) 321 of the membrane element 320. A portion of the water permeates the separating membrane layers 321 while the rest thereof flows along the surfaces of the separating membrane layers 321 to be discharged from the membrane element 320. The flow that permeates the membrane to be discharged is a permeated water 84 while the flow that flows along the membrane plane to be discharged is a concentrated water 85.

A hollow central pipe 325 is located at the center of the membrane element 320. About the separating membrane layers 321, any adjacent two thereof are laminated onto each other to form each pair. One end thereof is bonded to the central pipe 325. The separating membrane layers 321 are wound around the central pipe 325 to form a spiral form of the separating membrane layers 321. About spiral outside ends 324 of the paired separating membrane layers 321, the paired separating membrane layers 321 are sealed into each other to be made into a bag form. In other words, as shown in FIG. 2C, outside ends of a pair of separating membrane layers 71 and 72 (as the paired membrane element layers 321) are made into a bag form by use of a sealing region 73.

The central-pipe-325-side of the paired separating membrane layers 321, which are sealed to be made into the bag form at their outside ends, is connected to a hollow water channel inside the central pipe 325. In this way, water inside of the bag of the paired separating membrane layers 321 is collected into the central pipe 325. Between any adjacent ones of the bags of the separating membrane layers 321, a spacer 322 is arranged which will be detailed later. Inside the bag of the paired separating membrane layers 321, a mesh-form product 323 is arranged for rectifying the permeated water that has flowed in the bag of the paired separating membrane layers 321. The bag of the paired separating membrane layers 321, the spacer therein, the mesh-form product 323 therein are laminated onto each other, and this laminate is spirally wound around the central pipe 325. All of the spirally wound separating membrane layers 321 are held in a pressure-resistant outer circular cylinder 326 made of resin, and these constitute the membrane element 320.

In the RO membrane unit 32 including the membrane element 320, and the same membrane elements 320 as configured as described above, a water 80 to be treated that has flowed into each of the membrane elements 320 cross-flows onto the surfaces of its separating membrane layers 321. The water 80 is then separated into a permeated water, which has permeated the separating membrane layers 321 so that the water hardly contains substances to be separated, and a concentrated water, in which the substances to be separated are concentrated to be discharged from the membrane element 320.

More specifically, as shown in FIGS. 2A, 2B, and 2C, the water 79 to be treated, to be supplied into the separating membrane layers 321 flows from one of the two axial ends of the cylindrical reverse-osmosis-membrane element 320 into the element 320. The water is introduced into regions 74 and 75 that are each at the outer surface side of the bag of the paired separating membrane layers 321 and that each include one of the arranged spacers 322, so that the water creates a flow of the water 80 to be treated.

The water 80 to be treated that has flowed into the regions 74 and 75, in each of which one of the spacers 322 is arranged, advances inside the element 320 along the axial direction thereof. At this time, from a portion of the water 80, the substances to be separated are removed through the pair (any adjacent pair) of the separating membrane layers 321, and then the water portion passes through the paired separating membrane layers 321. A permeated water 81, which has permeated the paired separating membrane layers 321, is a purified water, and flows into the center of the element 320 as shown by an arrow 82 while the water 81 goes around into the circumferential direction (inward in the radius direction in the developed area in FIG. 2A) in the region where the mesh-formed product 323 is arranged inside the bag of the paired separating membrane layers 321. Subsequently, the water is collected through fine pores made in the central pipe 325 into the channel made in the central pipe 325, and then flows out through an outflow port 62 made in the center of a side plate of the element 320. When a water 83, which is the rest of the water to be treated, passes in the element 320, the water is decreased by a water volume of the permeated water 81, which has permeated the separating membrane layers 321, to be concentrated. Thus, the water 83 flows out, as the concentrated water 85, through a periphery region 63 of the side plate of the element 320.

The spacers 322 arranged in the regions to which the supplying water 80 is introduced are each formed by knitting polyethylene or polypropylene fibers each having a thickness of 0.5 mm or less into a mesh form. The mesh of the mesh-form spacers 322 is from about 3 to 7 mm. The spacers 322 may each be a spacer obtained by making many cut lines in a polyethylene or polypropylene sheet, and then opening the cut lines.

In the element 320, the separating membrane layers 321 are wound around the central pipe 325, so that the separating membrane layers 321 may be brought into contact with their spacers 322 to narrow the channel width of regions of the spacers into 10 μm or less. When the spacers 322 are made, particularly, into a mesh form, the spacers 322 become thick at their lattice points where the fibers cross each other, so that the spacers 322 make inroads into the separating membrane layers 321 to narrow the channel width.

When the width of the channels that is ensured by the thickness of the spacers 322 is narrowed and in this state the supplied water, which contains particles having a size in the order of submicrons, flows into the channel 74 or 75, or when the substances to be separated precipitate from the concentrated water, it is feared that the particles or the substances to be separated accumulate in the channels 74 and 75 between the paired separating membrane layers 321 and their spacers 322. The inventors' experimental researches have made it evident that the accumulation of the particles or the substances to be separated is remarkably caused within a range of 10 to 20 cm from the inlet in the element 320.

The thus-accumulating substances block the channels so that the supplied water does not flow even when the membrane plane blockage, which causes a rise in the intermembrane differential pressure, is not generated. Consequently, the treating performance of the RO membrane unit 32 is lowered. Thus, it is necessary to monitor the following: the channels 74 and 75 are blocked by the substances accumulating in the channels 74 and 75 formed by the spacers 322, so that the water passing resistance thereof is changed or increased.

In general, when the water passing resistance of the channels 74 and 75 increases, the RO membrane unit 32 is washed to decrease the water passing resistance. However, in the state that the channels are blocked in such a degree that the increase in the water passing resistance is detected as a rise in the pressure, a liquid for the washing does not enter the inside of the RO membrane unit 32 sufficiently so that the washing effect is small.

When the degree of the blockage is large so that the washing effect cannot be expected, the membrane element 320 should be indispensably exchanged. However, in order to exchange the element 320, it is necessary to stop the seawater desalting system 1 over a long period. Thus, the operating rate of the seawater desalting system 1 falls. Furthermore, costs for parts of the element 320, and for exchanging-work are added to running costs for the seawater desalting system 1, so that the total costs increase.

In order to solve this inconvenience, it is conceivable to wash the system periodically on a short period in which the blockage of the channels is not relatively caused so that no rise in the pressure is caused. However, when the washing is performed on the short cycle, costs for the washing liquid increases and further costs for treating waste liquid after the washing also increase. Additionally, by the frequent washing, the permeating performance of the membrane may be deteriorated by the washing liquid.

Thus, in the present invention, the monitoring unit 25 is located between the RO membrane supplying water tank 23 and the desalting unit 30, and the RO membrane is washed in a case where an indication of the blockage of the channels is observed even when no rise in the pressure is caused. Details of this monitoring unit 25 will be described hereinafter.

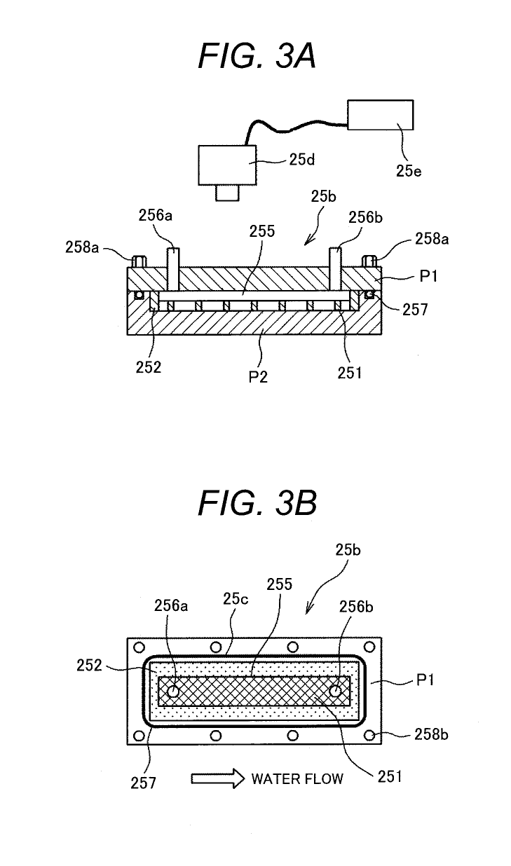

FIGS. 3A and 3B are each a view illustrating not only the monitoring device 25b and the image-pickup device 25d for picking up an image of this monitoring device, (also illustrated in FIG. 1 also), but also an image processing unit 25e therefor, each of the devices and the unit being possessed by the monitoring unit 25. FIG. 3A is a sectional view of the monitoring device 25b, in which the device 25b is viewed from the front side thereof. FIG. 3B is a top view of the monitoring device 25b. In the present embodiment, the monitoring device 25b is monitored through the image-pickup device 25d, and the resultant data are subjected to image processing. However, the image processing unit 25e is not necessarily essential, and the monitoring device 25b may be visually monitored.

As shown in FIG. 1, the monitoring device 25b is arranged in the branched channel PB. Furthermore, the monitoring device 25b has two flat plates P1 and P2 arranged in substantially parallel to each other, a fouling-generating member 251 held in a dent made in one of the plates (in FIGS. 3A and 3B, the lower flat plate P2), and a gap holding spacer 252 surrounding the periphery of the fouling-generating member 251 and held in the dent in the lower flat plate P2.

An O-ring groove is made in a circumferential edge region of the lower flat plate P2, and an O-ring 257 is fitted into this groove. The circumferential edges of the two flat plates P1 and P2 are used as flanges. Bolts 258a are passed through bolt holes made in the upper flat plate P1 and screw holes 258b made in the lower flat plate P2 to seal the space between the two flat plates P1 and P2.

Near an end of the upper flat plate P1 in the longitudinal direction thereof, an inflow port 256a through which the raw water (RO membrane supplying water) flows in is made, as well as an outflow port 256b through which the raw water flows out. At least one of the two flat plates P1 and P2 is a transparent plate made of acrylic resin, glass or some other. The image-pickup device 25d is arranged oppositely to the transparent flat plate.

The fouling-generating member 251 imitates the spacers 322 arranged in the membrane element 320, and is preferably made of polyethylene or polypropylene. In order to simulate flow inside the channels 74 and 75 of spacer-322-regions of the membrane element 320, the fouling-generating member 251 has an external shape equivalent to that of the spacers 322 used in the membrane element 320. Specifically, the fouling-generating member 251 may be a product obtained by knitting fibers into a mesh form, a sheet having projections, a sheet in which many holes are opened, or some other. The shape thereof is also rendered a shape permitting the formation of a gap in which the RO membrane supplying water flows certainly between the two flat plates P1 and P2.

In FIG. 3A, on the bottom surface of the dent in the flat plate P2, which does not obstruct the image-pickup device 25d, it is preferred to arrange a member made of a material identical with that of the RO membrane 321. In order to arrange the identical material, for example, the following method is adopted: a method of bonding a portion of the RO membrane 321 onto the flat plate P2; a method of forming the material identical with that of the RO membrane into a film directly onto the P2 surface; or a method of using a polyamide plate as the flat plate P2. However, it is not necessarily essential to use the material identical with that of the RO membrane 321 for the bottom surface of the dent in the flat plate P2. This appears to be because in the present monitoring unit, the interval of the gap between the fouling-generating member 251 and the flat plate P2 mainly causes fouling and thus the effect of the surface material of the flat plate P2 is small.

About the dimension of the monitoring unit 25, important is the gap between the two flat plates P1 and P2. The two flat plates P1 and P2 are made parallel to each other, or are arranged to make the interval therebetween narrower from the inflow port 256a toward the outflow port 256b. The interval between the flat plates P1 and P2 is set to 0.5 mm or less, and is made smaller than the thickness of the spacers 322 of the element 320 used in the membrane unit 32. This is for accelerating the generation of fouling in the monitoring unit 25.

The width of a channel 255 (the length thereof in a direction perpendicular to the water flowing direction) is 1 cm or more, more preferably from 1.5 to 4 cm. This is such a width that repetitive structures of the fouling-generating member can be contained in the channel so that the water flow can gain evenness.

The length in the flow direction of the channel 255 formed in the dent in the flat plate P2 is from 1 to 30 cm both inclusive. Fouling, which causes a rise in the water passing resistance (of the element 320), is frequently generated in a scope from the inlet of the element 320 to a spot about 15 cm apart therefrom; thus, when the length is at least 1 cm, fouling can be generated. Even when the effect of the downstream of the fouling-generation scope is considered, a phenomenon equivalent to a phenomenon generated actually in the element 320 can be realized when the length is about 2 times larger than the fouling-generation scope. When a scaledown of the present system and the approximation of the realizable phenomenon are considered, it is sufficient that the scope is from 10 to 20 cm.

The fouling-generating member 251 corresponds to the spacers 322 inside the membrane element 320. Accordingly, when a member identical with the spacers 322 in the membrane element 320 is used as the member 251, a phenomenon inside the RO membrane unit 32 arranged at the downstream of the monitoring device 25b can be faithfully realized in the seawater desalting system 1. In the case of expecting to accelerate a phenomenon that may be caused inside the RO membrane unit 32 and monitor the phenomenon, a shape different from that of the spacers may be used to take a preventive measures against fouling.

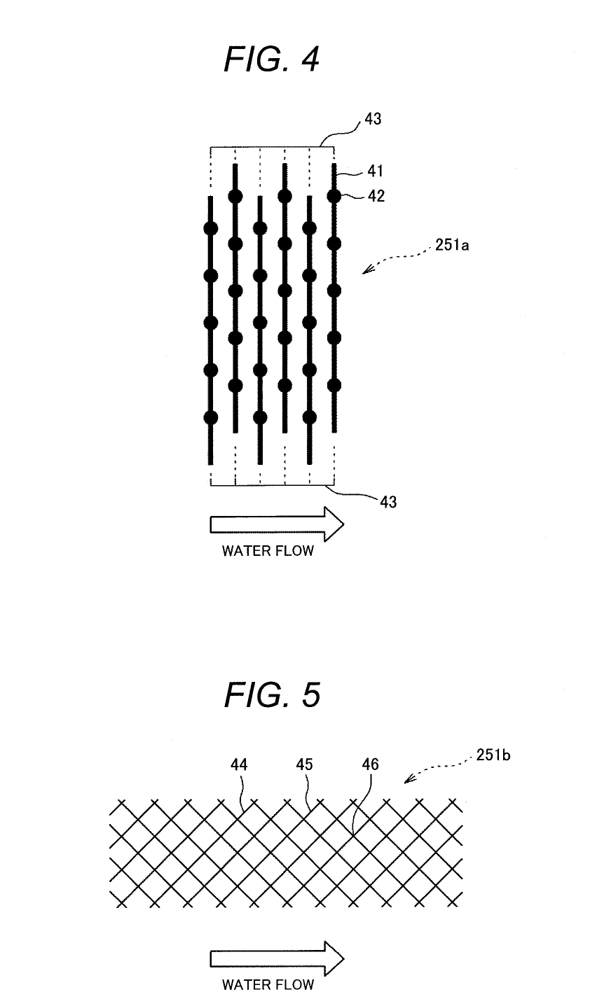

Examples of the shape of the fouling-generating member capable of accelerating the generation of fouling are illustrated in FIGS. 4, 5, 6A, and 6B. FIG. 4 is a top view of a fouling-generating member 251a, and partially illustrates the member. Fibers 41 in each of which dots 42 are formed at intervals are arranged in a direction perpendicular to an RO membrane supplying water. Positions of the dots 42 of any adjacent two of the fibers 41 are adjusted to be in a zigzag form. Each of the fibers 41 is fitted to a fastening members 43 at both of its ends. An appropriate tension is given to the fastening members 43 to be caused to act therebetween, thereby preventing the fouling-generating member 251a from rising up. The dots 42 are each formed by making fibers made of a material identical with that of the fibers 41 around.

FIG. 5 is a front view of a fouling-generating member 251b which is another example of the fouling-generating member. Its warps 44 and wefts 45 are alternately woven to be made into a mesh-form product. Intersectional points of the warps 44 and the wefts 45 form lattice points 46. The mesh of the mesh-form product is 2 mm or less. The mesh is made smaller than each of the intervals between the spacers 322 used actually in the element 320. In this way, a resistance based on the fouling-generating member 251b is made large to accelerate the generation of fouling.

In the two examples, it is preferred to use the material of fibers identical with that of the fibers used actually in the element 320. In short, fibers of polyethylene or polypropylene are used.

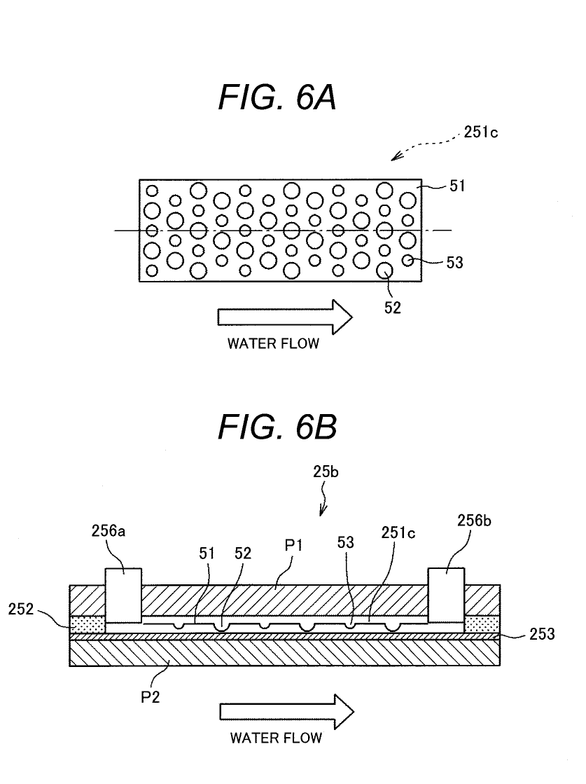

FIGS. 6A and 6B illustrate a fouling-generating member 251c which is still another example of the fouling-generating member. FIG. 6A is a top view of the fouling-generating member 251c, and FIG. 6B is a sectional view of a monitoring device 25b into which the fouling-generating member 251c is integrated. In FIG. 6B, the illustration of any sealing member and any fastening member formed at the periphery of the monitoring device 25b is omitted; however, naturally, the monitoring device 25b has such members, as has been illustrated in FIG. 3B.

Many spherical projections 52 and 53 are formed on a surface of a sheet 51 made of a transparent material to adjust a gap between channels in which an RO membrane supplying water flows.

One of the respective sizes of the projections 52 and 53 is large, and the other is small. The number of the species of the sizes of the projections may be three or more. This is for the following in the channels in the actual membrane element 320: in connection with a relationship between the fibers constituting the spacers 322 to be knitted into a mesh-form product and the separating membrane layers 321, the projections constitute regions having no fibers, regions each having one of the fibers, and regions in each of which any one of the lattice points, which are intersectional points of the fibers, is in contact with one or more of the separating membrane layers 321. In this way, in the monitoring device 25b, regions of the sheet 51 that have no projection can imitate the regions having no fibers; regions having the small projections can imitate the regions each having only one of the fibers; and regions having the large projections 52 can imitate the regions in each of which any one of the lattice points, which are intersectional points of the fibers, is in contact with one or more of the separating membrane layers 321.

The behavior of the RO membrane supplying water inside the monitoring device 25b is observed through the image-pickup device 25d. It is then determined whether or not fouling is generated, which results in the blockage of the channels. At this time, attention is paid to a change in the shape or the color of the fouling-generating member 251c. The blockage of the membrane plane, which affects the intermembrane differential pressure, is generated even by the adhesion of a very small amount of an organic substance thereto. When the adherend is small in quantity and is regarded as a substantially transparent substance, or when the adherend is made of a transparent material, it is difficult to observe the adherend optically.

However, when an adherend adheres to the spacers 322, the spacers 322 are swelled or colored by the adherend onto the spacers 322, so that a visually observable change is caused. Since this change is caused at a stage before a change in the pressure loss, the former change can be monitored by image-pickup observation. In the present example, the monitoring is performed with the naked eye. However, using the image processing unit 25e, a change of the spacers 322 or a change in the size of the adherend may be quantitatively analyzed. Instead of the image-pickup device, such as a CCD camera, a spectrometer may be used to determine quantitatively whether or not the adhesion is caused. These two methods may be used together.

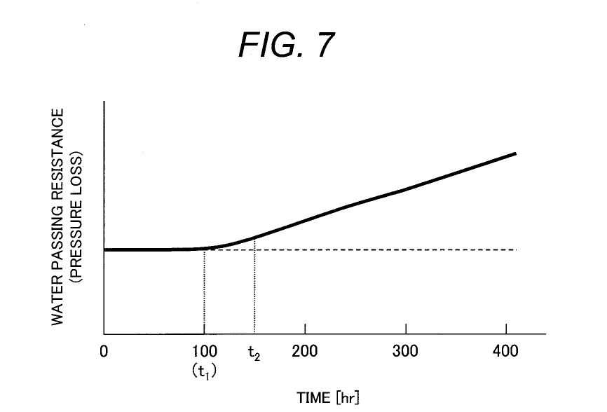

FIG. 7 is a graph showing an example of a monitoring result in the monitoring unit 25. The result is a result obtained by using the pressure gauges 26a and 26a set before and after the monitoring unit 25 (monitoring device 25b) and the image-pickup device 25d to examine a correspondence between the water passing resistance (of the unit 25) and picked-up images taken by the image-pickup device 25d. Its transverse axis shows the elapsed time from the start of the monitoring; and its vertical axis the differential pressure between the respective pressures detected by the pressure gauges 26a and 26a. The spacers 322 used in the case were mesh-form products wherein warps and wefts were knitted into each other.

At a time t1 when the water passing resistance started to rise up (in FIG. 7, a time when 100 hours elapsed), the spacers 322 were already colored on an image pickup screen of the image-pickup device 25d. At a time t2 after about 50 hours elapsed from the time t1, the water passing resistance increased significantly, so that the increase was detected. In other words, a change in the water passing resistance, which results in the blockage of the channels, can be earlier detected in such a case than in cases where the change is detected through a change in the flow pressure of a water to be treated.

As described above, the water passing resistance observed or measured in the monitoring unit 25 needs to be obtained by simulating the actual state of the RO membrane unit 32 or a state before the actual state, or to be obtained by simulating the flow of the water to be treated inside the RO membrane unit 32 faithfully, or simulating this flow while the state of the flow is accelerated. Thus, in order to raise the water passing resistance equivalently to that of the water to be treated in the RO membrane unit 32, or raise this resistance earlier than that of the water to be treated in the RO membrane unit 32, the linear flow rate of the water in the membrane plane in the monitoring device 25b is made equal to or more than that in the membrane plane of the RO membrane unit 32.

The average linear flow rate thereof in the RO membrane unit 32 is from 0.1 to 0.2 m/s. However, at the inlet side of the RO membrane unit 32, the linear flow rate reaches to as large a value as 0.5 to 0.7 m/s. Thus, the linear flow rate in the channel 255 made in the monitoring device 25b is set to a value from 0.7 to 1.0 m/s, which is larger than the linear flow rate in the RO membrane unit 32 arranged at the downstream. In order to increase the linear flow rate in the monitoring device 25b, the pump 25a, which is a small pump, and the valve 25c are set, or the diameter of the channel is changed to be decreased in the middle thereof.

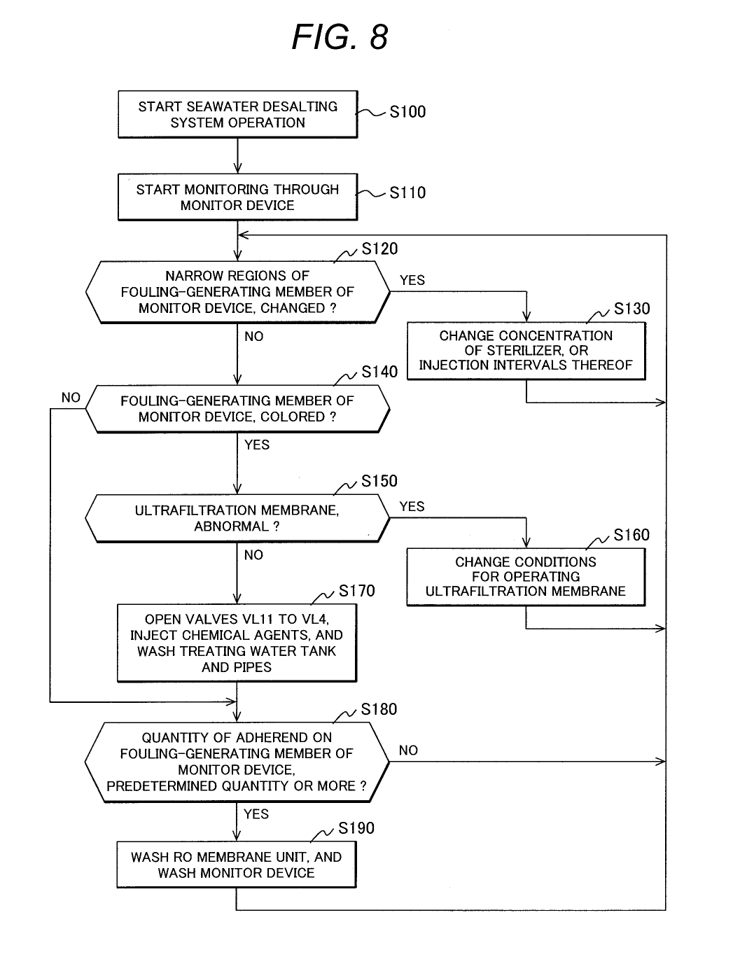

The following will describe an operation example of the seawater desalting system 1 having the monitoring unit 25, referring to FIG. 8. FIG. 8 is a flowchart of the operation of the seawater desalting system 1.

The operation of the seawater desalting system 1 is started (step S100). The CCD camera, which is the image-pickup device 25d, then starts to pick up images of the monitoring device 25b of the monitoring unit 25 (S110). Since the upper plate P1 of the monitoring device 25b is made of transparent acrylic resin or glass, the situation of the water to be treated, which flows inside the monitoring device 25b, can be monitored, as images picked up by the CCD camera 25d, through a monitor located in a control room not illustrated.

When seawater desalting treatment is advancing in the seawater desalting system 1, the screen of the monitor is periodically checked. At this time, the following (1), (2) and (3) are mainly targeted, and the individual units of the seawater desalting system 1 are controlled while contents monitored are analyzed through steps described below: (1) the effect of turbidity components is removed; (2) the proliferation of microorganisms is restrained; and (3) The washing timing of the RO membrane is decided.

Specifically, on the screen projecting the images picked up by the image-pickup device 25d of the monitoring unit 25, it is monitored whether or not a change is caused in narrow regions of the fouling-generating member 251 corresponding to the spacers of the RO membrane element (step S120). More specifically, in the case of the fouling-generating member 251 formed by knitting the warps and wefts, the proliferation of microorganisms is assumed when an image of a fibrous or gelatinous lump or a grown fibrous image is observed at the lattice points of the warps and wefts, or other spots. Thus, a change is made, for example, the concentration of the sterilizer is increased, or the sterilizer-charging intervals are shortened (step S130).

Next, it is monitored whether or not the fouling-generating member 251 of the monitoring device 25b is colored (step S140). The turbidity components are increased in quantity in the following case: a case where when the fouling-generating member 251 (any one of the members 251a to 251c) is a fibrous product as shown in FIG. 4 or 5, the whole of the fibers is colored; or when the member 251 is a sheet-form product as shown in FIGS. 6A and 6B, the whole of the sheet is colored. Thus, in this case, it is checked whether an abnormality is caused about the state of the separating membrane in the ultrafiltration membrane unit 22 of the pre-treating unit 20 for roiling-component-removal (step S150). The method for checking the abnormality of the ultrafiltration membrane unit 22 may be a method of measuring the respective turbidity component quantities in the water before and after the ultrafiltration membrane unit 22 with, for example, a turbidimeter to determine whether or not the removal rate thereof satisfies a target specified value.

When an inconvenience is caused in the separating membrane in the ultrafiltration membrane unit 22, the operation conditions are changed (step S160). Specifically, for example, the frequency of back washing or washing with a chemical agent is increased; the period for the washing is prolonged; or the concentration of the washing liquid for the chemical agent washing is increased. When no abnormality is caused in the ultrafiltration membrane unit 22, there may be a possibility that turbidity components are newly generated in the RO membrane supplying water tank 23, or the pipes from the ultrafiltration membrane unit 22 to the monitoring unit 25. Thus, a countermeasure there against is taken, for example, the supplying water tank 23 or the pipes are washed, or the injection volume from the sterilizer injecting part 24a is increased to remove a generated microorganism film (step S170).

Next, the element 320 needs to be periodically exchanged or washed, so that the timing of exchanging or washing the membrane element 320 inside the RO membrane unit 32 is determined through the images picked up by the monitoring device 25b. As described above, an increase in the water passing resistance (of the RO membrane unit 32) measured in the RO membrane unit 32 is generated at a timing later than the generation of actual fouling; it is therefore necessary to wash the RO membrane unit 32 before the water passing resistance increases so that a washing liquid is not easily put into the unit 32.

Thus, when an adherend is observed on the fouling-generating member 251 of the monitoring device 25b, the size of the adherend is measured. This measured value is gained by subjecting the projection area of the adherend occupying the image picked up by the image-pickup device 25d to image processing in the image processing unit 25e. When the resultant adherend size turns to a threshold value decided beforehand (for example, 5%) or more (step S180), the RO membrane unit 32 is washed with a washing liquid, and further the inside of the monitoring device 25b is also washed under the same conditions as used in the RO membrane (step S190). This step makes it possible to wash the fouling-generating member 251 of the monitoring device 25b to make the effect of the washing sure.

As described above, in the seawater desalting system 1 of the present embodiment, the monitoring device 25b is arranged at the upstream of the RO membrane unit 32 to interpose the branched pipe therebetween, and the fouling-generating member 251 imitating the spacers is arranged inside the monitoring device 25b. The flow of a water to be treated inside the monitoring device 25b is made visible to be monitored by the image-pickup device 25d. Thus, the generation of fouling in the RO membrane unit 32 can be detected earlier in this case than in a case according to a rise in the water passing resistance of the RO membrane unit 32, which is a rise in the pressure in the unit 32.

In this way, a washing liquid can easily be injected into the RO membrane unit 32 to prevent an inconvenience that the water passing resistance is raised by the development of fouling to cause a failure in the washing of the RO membrane unit 32. In particular, the generation of fouling can be detected earlier in this case than cases where the water passing resistance is detected through a rise in the pressure, thus improving the reliability of the seawater desalting system 1. Moreover, the contamination degree of the pre-treating unit or the desalting unit can be known before the water passing resistance rises, so that the seawater desalting system 1 can be optimally operated at any time by changing operating conditions for the pre-treating unit or desalting unit. As a result, seawater can be effectively desalted.

In the above-mentioned embodiment, the monitoring device 25b is located to make the channel 255 of the monitoring device 25b sideway. However, the channel may be made vertical. In this case, it is preferred to supply a water to be treated from the lower, and discharge the water from the upper.

In the embodiment, the generation of fouling in the RO membrane unit is detected by making the visualization. However, it is allowable to monitor a change in an index such as the reflectivity or the reflection spectrum, as well as a change in the color or the shape of the picked-up images. At the position where the monitoring device in the embodiment or a position at the upstream side of the RO membrane unit, a sensor capable of monitoring the blockage of the separating membrane may be together located.

In the RO membrane unit described in the embodiment, cross flow filtration is adopted. In the cross flow filtration, it is necessary to control two pressures. One thereof is the differential pressure between the separating membrane layers 321 and 321, and the other is the pressure difference (water passing resistance) between the supplying-water-79-side and the concentrated-water-85-side of the membrane element 320, which is the pressure loss of the element 320. In the embodiment, the water passing resistance based on the blockage of the channel, which is the latter of these two pressures, is detectable. This matter makes it possible to promote the removal of deposits, which cause a rise in the water passing resistance, in treatment before the filtration through the RO membrane, so as to control the water treatment optimally.

### REFERENCE SIGNS LIST

1: Seawater desalting system (water treatment system), 10: seawater taking unit, 20: pre-treating unit, 25: monitoring unit, 25b: monitoring device, 25d: image-pickup device (CCD camera), 25e: image processing unit, 30: desalting unit, 32: RO membrane unit, 251: fouling-generating member, 321: RO membrane, 322: spacers (RO-membrane water-to-be-treated side spacer), P1: transparent flat plate, P2: flat plate, PM: main pipe, and PB: branched pipe (bypass pipe).

1. A water treatment system, comprising:
a pre-treating unit for pre-treating a raw water;
a desalting unit, having a separating membrane unit which has an RO membrane element in which separating membrane layers arranged as said separating membrane and spacers for keeping said separating membrane layers apart from each other are formed to be wound into a spiral form, for separating substance to be separated from said raw water pre-treated in said pre-treating unit using a separating membrane; and
a monitoring unit between said pre-treating unit and said desalting unit,
said monitoring unit further comprising:
a monitor device, fitted to a bypass pipe of a pipe through which said pre-treating unit and said desalting unit are connected to each other, for having a closed vessel having at least one transparent or semitransparent surface; and
an image-pickup device for making said raw water flowing in said closed vessel visible through said transparent or semitransparent surface,
wherein said closed vessel includes a fouling-generating member imitating said separating membrane and said spacers, said image-pickup device makes it possible to pick up an image of said raw water flowing in said fouling-generating member through said transparent or semitransparent surface, and said monitor device has a structure in which fouling is more easily generated than in the structure which said desalting unit has.

2. The water treatment system according to claim 1, wherein said fouling-generating member of said monitor device has fibers, in each of which dots are formed at intervals of a predetermined distance, are arranged in a direction perpendicular to said flow of a water supplied to said RO membrane, and the positions of said dots of any adjacent two of said fibers are designed to be in a zigzag arrangement.

3. The water treatment system according to claim 1, wherein said spacers are each a mesh-form product, and said fouling-generating member of said monitor device is formed into a mesh-form product in which warps and wefts are alternately woven, and a mesh of said mesh-form fouling-generating member is smaller than that of said spacers of said RO membrane.

4. The water treatment system according to claim 1, wherein said fouling-generating member of said monitor device has many spherical projections.

5. The water treatment system according to claim 1, wherein said monitor device is larger in water passing resistance than said separating membrane unit.

6. The water treatment system according to claim 5, wherein said fouling-generating member of said monitor device has a membrane plane larger in linear flow rate than the membrane plane of said RO membrane element of said separating membrane unit.

7. The water treatment system according to claim 1, wherein said pre-treating unit comprises a chemical agent injecting unit having a sterilizer injecting part for sterilizing bacteria contained in said raw water, and a coagulant injecting part for coagulating said substance to be separated which is contained in said raw water, and an ultrafiltration membrane unit.

8. The water treatment system according to claim 1, wherein in said monitor device, a space is formed between two flat plates arranged in parallel to each other, at least one of the two being transparent or semitransparent, and said fouling-generating member is arranged at an image-pickup side of said space.

9. The water treatment system according to claim 7, wherein in said monitor device, a space is formed between two flat plates arranged in parallel to each other, at least one of the two being transparent or semitransparent, and said fouling-generating member is arranged at an image-pickup side of said space.

10. The water treatment system according to claim 1, wherein said fouling-generating member is formed to comprise polyethylene or polypropylene.

11. The water treatment system according to claim 7, wherein said fouling-generating member is formed to comprise polyethylene or polypropylene.

12. The water treatment system according to claim 1, wherein said separating membrane is a reverse osmosis membrane.

13. A water treating method in a water treatment system having a separating membrane unit of using a separating membrane to separate, from a raw water, a substance to be separated, and preventing blockage of said separating membrane that is based on fouling generated by adsorption of said substance to be separated into said separating membrane unit, the method comprising the steps of:
a step for bypassing said raw water at the upstream side of said separating membrane unit;
a step for causing said bypassed raw water to flow into a monitor device having therein a fouling-generating member having a structure in which fouling is more easily caused than in said separating membrane and a spacer which said separating membrane unit has; and
a step for picking up an image of said raw water flowing into said fouling-generating member through an image-pickup device, thereby forecasting the generation of the fouling.

14. The water treating method in the water treatment system according to claim 13, wherein when said fouling-generating member is colored, or when a proportion of an area of a picked-up image of an adsorbate onto said fouling-generating member in said area of the whole of the image picked up by said image-pickup device exceeds a predetermined value, it is determined that the fouling is generated, and then at least one of the following is performed: the water treatment system is washed; a chemical agent is injected into the system; and conditions for operating the ultrafiltration membrane is changed.

15. The water treatment method in the water treatment system according to claim 13, wherein said water treatment system is a seawater desalting system.
